(19) United States
(12) Patent Application Publication
(10) Pub. No.: US 2026/0357378 A1
(43) Pub. Date: Nov. 12, 2026

(54) LITHIUM EXTRACTION

(71) Applicant: Watercycle Technologies Ltd, Manchester (GB)

(72) Inventors: Sebastian James Allender LEAPER, Manchester (GB); Ahmed ABDELKARIM, Manchester (GB)

(21) Appl. No.: 19/139,622

(22) PCT Filed: Dec. 13, 2023
(86) PCT No.: PCT/EP2023/085653

§ 371 Date: Jun. 16, 2025

(30) Foreign Application Priority Data
Dec. 14, 2022 (GB) 2218894.0

(51) Int. Cl. C22B 26/12; B01J 39/17; C01D 15/02; C22B 3/42; C22B 3/44

(52) U.S. Cl. CPC C22B 26/12; B01J 39/17; C01D 15/02; C22B 3/42; C22B 3/44

(57) ABSTRACT

Described is a method of direct lithium extraction from a lithium-containing feedstock, the method comprising extraction, release and precipitation steps. In the release step, in which a release solution comprising a protic acid is contacted with the lithium-ion-exchange material, whereby lithium ions are released from the lithium-ion-exchange material into the release solution, the protic acid is an organic acid. In the precipitation step, in which a precipitant is mixed with the lithium-enriched release solution, the precipitant is a non-lithium containing alkali.

### FIELD OF THE INVENTION

The present invention relates to a method of processing lithium-containing solutions to extract or recover lithium, in the form of lithium hydroxide, for further use. More particularly, the invention provides a method of extracting lithium through direct lithium extraction.

### BACKGROUND

Lithium hydroxide (specifically, lithium hydroxide monohydrate) is one of two main forms of lithium used for the production of lithium-ion batteries. The demand for lithium hydroxide is growing exponentially due to the increased demand for electric vehicles. However, the production of lithium hydroxide requires energy-intensive electrolytic methods or additional precipitation steps compared to the second main form, lithium carbonate.

Direct Lithium Extraction (DLE) is a process involving the selective extraction of lithium from aqueous sources such as natural brines, seawater or industrial wastewaters. This can be achieved in various ways including adsorption, ion exchange, electrodialysis, nanofiltration or others.

Of these, ion exchange represents an energy-efficient process that is driven by adjustments in pH rather than applied pressure or electrical current. When flowing a lithium-containing feedstock solution such as brine over lithium-selective ion exchange media (in an extraction step), lithium ions migrate into the selective media (that is, are extracted or leeched from the feedstock), leaving other components in the feedstock, to replace ions already present. Once the lithium has been taken up by the media, the remaining feedstock can be removed. By then flowing a dilute acid solution (release solution) through the media (in a release step), protons from the acid exchange with the lithium ions held in the media (releasing the lithium ions into the release solution). The lithium-rich release solution that is created from this process can then undergo further concentration and crystallisation stages to produce salts such as lithium hydroxide or lithium carbonate. These two salts are the main form of lithium used in the manufacture of lithium-ion batteries.

Such lithium-selective ion exchange media are sometimes referred to as Lithium-Ion Sieves (LISs).

Typically, the acid used to release the lithium ions from the lithium-selective ion exchange medium is hydrochloric acid. When hydrochloric acid is introduced into the column, lithium ions are removed and the enriched release solution that is formed comprises lithium chloride (typically with small amounts of impurities).

That lithium chloride still needs to be converted into lithium carbonate or more preferably lithium hydroxide in order to be used in battery production.

Lithium carbonate can be produced from the lithium chloride-containing release solution by way of addition of sodium carbonate as per equation (1):

2LiCl_{(aq)}+Na₂CO_{3 (aq)}→Li₂CO_{3 (s)}+2NaCl_{(aq)} (1)

The lower solubility of lithium carbonate compared to sodium carbonate results in its precipitation out of solution, where it can be separated from the remaining sodium chloride solution.

In order to then produce lithium hydroxide, an additional processing step is required, treating the lithium carbonate with calcium hydroxide as per equation (2). This forms a precipitate of calcium carbonate, leaving a lithium hydroxide solution which can then be crystallised through evaporation or antisolvent addition.

Li₂CO_{3 (s)}+Ca(OH)_{2 (aq)}→2LiOH_{(aq)}+CaCO_{3 (s)} (2)

In this case, the low solubility of calcium carbonate results in its precipitation, leaving the lithium hydroxide in solution.

However, the conversion of lithium chloride to lithium carbonate in equation (1) results in some lithium remaining in solution, given that lithium carbonate has moderate solubility in water (12.9 g/L at 25 °C). Therefore the inventors have found that this methodology has some efficiency detriment.

Furthermore, while this methodology is possible, the need for both sodium carbonate and calcium hydroxide reagents to perform the two steps adds cost and complexity to the process. This is especially true as each step requires its own solid-liquid separation process, which can result in losses of the desired product(s) and will incur additional energy costs.

The present invention has been devised in the light of the above considerations.

### SUMMARY OF THE INVENTION

The present inventors sought to provide an improved and more environmentally friendly process for DLE of lithium from lithium-containing solutions such as geothermal brines. In doing so the inventors have found that by replacing hydrochloric acid with an organic acid (such as oxalic acid or citric acid) in the release step, a solution of the lithium salt of the organic acid is produced and hence included in the lithium-enriched release solution. This solution can be reacted with a suitable precipitant, in the form of an alkali (suitably a non-lithium metal hydroxide) to produce lithium hydroxide, without having to first produce lithium carbonate.

So, rather than first precipitating lithium carbonate and then adding a non-lithium metal hydroxide (such as calcium hydroxide), the non-lithium metal hydroxide can be added directly to the solution of the lithium salt of the organic acid (i.e. the lithium enriched release solution). For example, calcium hydroxide may be added to a solution of lithium oxalate as per equation (3) for lithium oxalate.

Li₂C₂O_{4 (aq)}+Ca(OH)_{2 (aq)}→2LiOH_{(aq)}+CaC₂O_{4 (s)} (3)

In this reaction, the insoluble calcium oxalate precipitates out of solution, leaving the lithium hydroxide (which is highly soluble) in solution. This solution may be further processed to produce solid lithium hydroxide via methods such as evaporative crystallisation or antisolvent crystallisation which are well known in the art.

Other organic acids and non-lithium metal hydroxides may be used for which the non-lithium metal cation of the hydroxide and the organic conjugate base anion of the organic acid yields a product that is insoluble or has low solubility in water.

Accordingly, in a first aspect, the invention provides a method of direct lithium extraction from a lithium-containing feedstock, the method comprising:
(i) an extraction step, in which the lithium-containing feedstock solution is contacted with a lithium-ion-exchange material, whereby the lithium-ion-exchange material is loaded with lithium ions;
(ii) a release step, in which a release solution comprising a protic acid is contacted with the lithium-ion-exchange material, whereby lithium ions are released from the lithium-ion-exchange material into the release solution; and
(iii) a precipitation step, in which a precipitant is mixed with the lithium-enriched release solution; wherein the protic acid is an organic acid; and the precipitant is a non-lithium containing alkali.

In the release step, the lithium ions enter the release solution to form the lithium salt of the organic acid, to be replaced in the lithium-ion-exchange material by protons. Then, in the precipitation step, by a further ion exchange lithium hydroxide is formed along with the non-lithium metal salt of the organic acid. That non-lithium metal salt of the organic acid precipitates out of the solution, leaving a solution of lithium hydroxide.

It will be recognised that non-lithium containing alkali means an alkali which does not contain lithium. Alkali as used herein means any base that is soluble in water and forms hydroxide ions, or the solution of a base in water. The alkali therefore is necessarily a source of hydroxide ions, as is necessary for the desired ion exchange to form lithium hydroxide, and the consequent precipitation. Suitably a non-lithium metal hydroxide is used.

The organic acid is suitably chosen to release lithium ions in the release step; it is therefore a protic acid. The non-lithium metal hydroxide is chosen such that the salt of its metal with the organic acid is not soluble in water to an appreciable degree (<1 mg/mL, suitably <0.5 mg/mL, more suitably <0.1 mg/mL), so that it precipitates in the precipitation step.

The organic acid may suitably be, for example, citric acid or oxalic acid. Of these oxalic acid may be preferred.

The precipitant may preferably be, for example, calcium hydroxide, magnesium hydroxide or barium hydroxide. Of these calcium hydroxide may be preferred.

In the extraction step, a lithium-containing feedstock has lithium ions ‘removed’ from it by the lithium-ion-exchange material. Those are replaced by, generally, protons. This extraction step is therefore characterised as a first ion exchange.

In the release step, a release solution is used to perform the equivalent ion exchange, in reverse. That is, protons from the release solution exchange with lithium ions and release the lithium ions into the release solution.

The depleted feedstock is suitably removed after the extraction step. It may then be, for example, subject to further processing; or recycled back into the feed to act as a ‘new’ feedstock for lithium ion extraction. A single aliquot of feedstock may be subject to the above extraction and release steps multiple times (cycles), gradually reducing the lithium content each time.

In some embodiments, after the depleted feedstock is removed, there is a first washing step in which the lithium-ion-exchange material is washed with water (suitably deionised water). The first washing step may be conducted for, for example, about 10-120 minutes.

In the extraction step, it will be appreciated that the desired ion exchange (lithium in the feedstock switching with protons in the lithium-ion-exchange material) can be driven by using a feedstock of raised pH (i.e. a proton-poor environment). Therefore, the feedstock used in the extraction step may suitably have a pH of greater than 7, for example greater than 8 or greater than 9. This may be achieved in a step, before the extraction step, of increasing the pH of the feedstock by addition of an alkaline solution or basic compound, for example NaOH, in the amount required to raise the pH to the desired level.

The extraction step may suitably be conducted at a temperature above room temperature, for example around 25-70 °C, suitably 50-70 °C. Where geothermal brines are used as the feedstock, they are often naturally of elevated temperature (for example about 40-70 °C) and hence the extraction step necessarily proceeds at above room temperature where such a feedstock is used directly from the ground source.

In the release step, it will similarly be appreciated that the desired ion exchange (lithium in the lithium-ion-exchange material switching with protons in the release solution) can be driven by using a release solution of reduced pH (i.e. a proton-rich environment); hence the inclusion of protic acid in the release solution. The release solution may suitably have a pH of less than 7, for example less than 6 or less than 5.

For example, a suitable choice of release solution is an acidic solution such as citric acid, for example a 0.2 M citric acid solution. With such a release solution, after the release step a lithium citrate solution is obtained. This can be processed to extract lithium citrate (for example by crystallisation, precipitation etc.). Lithium citrate can then be processed to form, for example, lithium hydroxide as described above.

The release step may suitably be conducted at a temperature above room temperature, for example around 25-70 °C, suitably 50-70 °C.

The lithium-ion-exchange material may suitably comprise a lithium-ion selective material (lithium-ion sieve) and a matrix material.

The lithium-ion-exchange material may suitably be provided in the form of beads or hollow fibers, with hollow fibers being preferred.

The hollow fibers themselves comprise (that is, preferably are in the form of) membranes, comprising a matrix material and an ion selective material.

In the lithium-ion-exchange material, preferably the matrix material comprises or consists of PES. In some embodiments, lithium metal oxides and their hydrogen precursors are particularly suitable for use as a lithium selective material held in the matrix material. Lithium manganese oxide (LMO) and its corresponding hydrogen manganese oxide (HMO) derived from, and lithium titanium oxide (LTO) and its corresponding hydrogen titanium oxide (HTO) derived from LTO are suitable.

Preferably the ion selective material comprises LTO or HTO derived from LTO. That is particularly the case where the matrix material is PES.

Before the extraction step, the selective material may be subjected to a priming step, wherein it (especially, LTO or LMO contained within it) is contacted with a priming solution (which may have the same properties as the release solution discussed herein, especially it may be a protic acid). This extracts lithium ions from the LTO or LMO, leaving spaces which are filled with protons from the priming solution. This generates HTO (derived from LTO) or HMO (derived from LMO). Then, during the extraction step, the HTO (derived from HTO) or HMO (derived from LMO) selectively ion exchanges its protons for lithium ions from the feedstock. The spaces remain the right size for lithium ions because of the LTO-derivation of the HTO and the LMO-derivation of the HMO; accordingly HTO derived from LTO or HMO derived from LMO can act as a selective sieve or adsorbent for lithium ions.

The inventors observe that the use of organic acids in the adsorption-desorption DLE process may have the following advantages: (a) the process comprises one fewer steps than the conventional method; (b) the process reduces impurities in the lithium enriched solution produced in the second step; and (c) the overall yield may be increased due to the lower solubility of the precipitated organic acid salts when compared to lithium carbonate.

As the above described ion exchange steps are highly selective for lithium, the precipitate from the (iii) precipitation step comprises a salt of the organic acid with few impurities. This allows for further processing or re-sale of the precipitate, making the process more environmentally friendly.

The claimed processes are advantageous when compared to the known methods of the prior art which comprise multiple solid-liquid separations and non-zero solubility of by-products results in expensive and contaminated lithium hydroxide. This can detrimentally affect the economics of the process and produces more waste.

The invention includes the combination of the aspects and preferred features described except where such a combination is clearly impermissible or expressly avoided.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

### Direct Lithium Extraction

Direct lithium extraction (DLE) is a process where lithium is selectively extracted from impure solutions containing large amounts of multiple ionic species, wherein the majority of other components are left in solution. There are a number of DLE techniques known in the art, including electrodialysis, nanofiltration, adsorption and ion-exchange. The latter two approaches hold the most promise in terms of lithium selectivity, energy consumption and cost. DLE represents an alternative to conventional lithium brine extraction processes which utilise successive crystallisation stages (often with the use of evaporation ponds) which remove impurity compounds such as sodium chloride and leave the lithium in solution.

General DLE methods are well known in the art and will not be discussed in great detail here.

For example, the selective material may be provided as beads in a column, with the feedstock poured into/through the column; or it may be provided in the form of hollow fibers, with the feedstock fed through or over the fibers. This facilitates the uptake of the lithium and replaces protons in the material. This initial contact, removing the lithium from the feedstock and ‘storing’ it in the selective material, can be termed an ‘extraction step’ of the DLE process.

In order to conserve charge, clearly, in order to desorb (release) the lithium ions they must be replaced with a suitable cation; this is often a proton as suitable protic acidic solutions are readily available. Similarly, using basic solutions encourages the adsorption (take up) of lithium from solution, by removing protons from the lithium-ion sieve material. By varying pH, the selective ‘adsorption’ (take up) and ‘desorption’ (release) of lithium can be carefully controlled. A more basic feedstock solution provides the fastest lithium extraction rate; a more acidic release solution provides the fastest lithium release rate. However, rate must also be balanced against other factors such as acid/base safety and toxicity, additional cost and so on.

### Lithium Selective Material

A lithium selective material (Lithium-Ion Sieve, LIS) is needed for the desired ion exchanges to occur in the extraction and release steps.

It may be for example a metal organic framework, a zeolite, a layered double hydroxides or a metal oxide. Lithium metal oxides and their hydrogen precursors are particularly suitable for use as a lithium selective material held in the matrix material. Lithium manganese oxide (LMO) and its corresponding hydrogen manganese oxide (HMO) derived from LMO, and lithium titanium oxide (LTO) and its corresponding hydrogen titanium oxide (HTO) derived from LTO are suitable.

[It will be recognised that, of course, during the ion exchange reaction a compound such as lithium manganese oxide (LMO) will be converted, to at least some degree, to hydrogen manganese oxide (HMO) on contact with the release solution; it will convert back when it leeches lithium ions from a suitable feedstock. Accordingly the ion selective material may be accurately described as both LMO and HMO derived from LMO depending on its state of lithium ion loading. The applies equally to LTO and HTO derived from LTO, of course.]

Typically, the lithium selective material is not used in the pure form, but it is rather contained within or embedded in a matrix.

The matrix used here is not particularly limited given that it has good chemical and thermal stability. Suitable matrix materials include ceramics and polymers. Suitable ceramics include oxides such as alumina, zirconia and titania. Suitable polymers include both thermoplastics and thermosetting plastics. In some preferred embodiments the matrix material comprises one or more selected from: polysulfone (PSU), polyethersulfone (PES), polyketone (PK), polyetherketone (PEK), polyetheretherketone (PEEK), polyetherketoneketone (PEKK), polyimide. In some embodiments it consists of one of those. PES is particularly preferred. Therefore preferably the matrix material comprises or consists of PES.

The matrix is suitably porous; this increases the flow of the feedstock to the selective material (which may not necessarily be present on the outer surface of the matrix material) and facilitates transfer of lithium ions. The pores effectively increase the active surface area of the material. Accordingly larger pores, for example of an average pore size 0.1-2 μm, for example 0.5-1 μm, are preferable.

For the present lithium-ion-exchange material, a porosity of ≥60% may be suitable, in particular ≥80%. The pores may have a size (D₅₀) of ≤2 μm, for example ≤1 μm.

The selective material may suitably be provided in the form of particles.

In some embodiments, the particle size of the selective material is ≤50 μm, suitably ≤25 μm, or ≤10 μm. Most suitable is a particle size of ≤5 μm, or ≤3 μm.

On the other hand, the particles may suitably have a size of ≥200 nm, for example ≥400 nm, ≥1 μm, or ≥2 μm.

### Lithium-Ion-Exchange Material

As explained above, the present lithium-ion-exchange material includes a selective material and a matrix material. It may be provided in various morphologies; for example, it may be formed into beads (for example, substantially spherical beads of average diameter 0.01-10 mm) or, more suitably, into a membrane form.

Such a membrane might be a simple flat (e.g. cast) membrane, or have a more complex structure such as that of a hollow fiber. Hollow fiber membranes have been found by the inventors to have several advantages in DLE processes; in particular, a high useful surface area especially where the feedstock is flown in contact with the lithium-ion-exchange material.

Such hollow fibers are known in the art of water treatment; they are elongate, generally extruded members with a bore (hollow part) inside the substantially circular cross-section fiber.

A hollow fiber morphology of the material may be preferable as a feedstock brought into contact with the fiber has surface contact with a large active area. Hollow fibers can also be packed into a housing to form a membrane module; flow of feedstock through the module again allows high surface contact and hence efficient lithium extraction and release.

Suitable hollow fiber dimensions will be apparent to those skilled in the art. For example, a hollow fiber length of 0.2-2 m, an outer diameter of 0.4-5 mm, and a wall thickness of 10-200 μm may be used.

The hollow fibers themselves may have, for example, a length of about 1 m, an outer diameter of about 1 mm, and an inner (bore) diameter of about 0.9 mm.

Methods of making suitable beads or membranes will be apparent to those of skill in the art. Hollow fiber membranes are used often in water treatment technologies; general methods for their fabrication are also well know.

### Extraction Step

In the extraction step, the lithium-ion-exchange material is contacted to a lithium-containing solution (feedstock). Suitably this can be done batch-wise or using a continual flow of the lithium-containing solution.

Lithium-containing brines are a typical feedstock for DLE, typically containing from 50 to 4000 ppm lithium content. The brines typically also contain multiple other ionic species including Na⁺, K⁺, Ca²⁺, Mg²⁺, F⁻, Cl⁻, Br⁻, SO₄²⁻, PO₄²⁻, NO₃⁻, CO₃²⁻, and HCO₃⁻.

Other sources of lithium-containing solutions suitable as a feedstock include the product of leeching lithium from solid materials such as lithium-rich ores, lithium-rich recycled material, lithium-containing anodes and the like. This is often done using sulfuric acid, resulting in acidic lithium-containing solutions.

Before use in feedstock solution used in the invention, the feedstock is preferably adjusted to a pH of >7, optionally the pH may be raised yet higher, for example >8, >9, >10 or >11.

Suitable bases used to adjust the pH of the feedstock solution are not particularly limited as the lithium-ion sieve is highly selective for lithium ions. Suitable bases include NaOH, KOH, NaCO₃, KCO₃, NaHCO₃, KHCO₃, NH₄OH, ammonium carbonate, ammonium persulfate, ammonia, Ca(OH)₂ and Ba(OH)₂ (and their associated oxides). In terms of cost, NaOH is preferred.

The extraction step, as well as suitably being conducted at raised pH, may also or instead suitably be conducted at raised temperature (that is, >room temperature; for example >30 °C, >40 °C, >50 °C, >60 °C or >70 °C).

A temperature of 25-70 °C, and particularly 50-70 °C, may be preferred,

The length of time for which there is contact between the feedstock and the selective material depends on several factors, for example how the selective material is provided. If it is provided in fibers, or a column, through which a feedstock is flown, the rate of flow is important. If the selective material is simply placed in contact with a stationary feedstock for some length of time, the time it is left is the relevant feature.

In some embodiments, the extraction step may be conducted for 10-150 minutes.

After a given time, the de-lithiated feedstock is suitably removed from contact with the selective material, and the selective material may be rinsed with fresh water. This can remove any impurities loosely bound to the lithium-ion-exchange material before the release step is carried out.

### Release Step

In order to release the lithium from the selective material, a protic acidic solution (release solution) is introduced; this replaces the lithium ions with protons. The lithium is released from the selective material, forming a lithium-rich solution which can be removed for further processing. This can be termed a ‘release step’ of the DLE process.

As mentioned above, the present invention uses an organic acid in the release step. Suitable acids include oxalic acid and citric acid. Citric acid is preferable as it is a relatively easily obtainable, low toxicity acid which provides lithium citrate solutions that are readily processed.

On the other hand, oxalic acid may be preferred due to the relatively lower solubility of metal oxalates (especially calcium oxalate, 6.1 mg/L at 20 °C, where the precipitant is calcium hydroxide) than of metal citrates (especially calcium citrate, 850 mg/L at 18 °C, where the precipitant is calcium hydroxide).

The pH of the release solution (which is generally aqueous) depends of course on the acid included in it and how much is included; generally, it has a pH <7, for example <6, <5, <4, or <3.

In the release step, the lithium-ion exchange material is exposed to a solution of an organic acid. Suitably this can be done batch-wise or using a continual flow of organic acid solution.

The organic acid may be one which comprises a carboxylic acid group. Optionally, the organic acid comprises two or more carboxylic acid groups.

The organic acid is not particularly limited, provided the solubility of its lithium salt is greater than that of another metal salt of the organic acid. Suitable organic acids include oxalic acid, malonic acid, succinic acid, maleic acid, fumaric acid, citric acid, malic acid, and tartaric acid. Of these, citric and especially oxalic acid are preferable as lithium oxalate is soluble in water whereas other oxalate salts are insoluble in water.

It is also noted by the inventors that calcium is a common impurity in some lithium-containing feedstock solutions; it sometimes is carried through to the release step. Therefore by using a release solution that generates an insoluble calcium salt, such as oxalic acid (calcium oxalate) this impurity can easily be removed in the present process.

The release step may suitably be conducted at raised temperature (that is, >room temperature; for example >30 °C, >40 °C, >50 °C, >60 °C or >70 °C).

The release step may suitably be conducted at up to 70 °C. A temperature above room temperature, for example around 25-70 °C, suitably 50-70 °C, may be preferred.

### Precipitation Step

In the precipitation step a precipitant is added to the lithium-enriched release solution in order to perform a double-displacement reaction to liberate lithium hydroxide and precipitate the organic conjugate base anions as an insoluble salt.

Suitably, the precipitant is an alkali (that is, produces an alkali solution upon addition to water; any base that is soluble in water and forms hydroxide ions, or the solution of a base in water). Suitably, the precipitant contains metal cations that form insoluble salts with organic acids such as oxalic acid and citric acid

Suitable precipitants for use in the precipitation step may include alkaline earth metal hydroxides such as Mg(OH)₂, Ca(OH)₂, Sr(OH)₂ and Ba(OH)₂, alkaline earth metal oxides (which hydrate to provide alkaline earth metal hydroxides) such as MgO, CaO, SrO and BaO, or an alkali metal hydroxide such as NaOH or KOH.

Clearly the precipitant cannot be a lithium hydroxide or oxide.

In order to minimise cost, the precipitant is preferably Mg(OH)₂ or Ca(OH)₂, more preferably Ca(OH)₂.

When the organic acid is oxalic acid, the precipitant is preferably Ca(OH)₂ as the solubility of calcium oxalate is the lowest of alkaline earth oxalates.

In some embodiments, the precipitant is added in the precipitation step as an aqueous solution.

Alternatively the precipitant may be added in the precipitation step as a solid.

The precipitant is added in sufficient volume to cause precipitation of the organic conjugate base anions as an insoluble salt. After the precipitation step is complete, the precipitate may be separated from the supernatant solution by any suitable means, for example, gravity separation, filtration, centrifugation, hydrocyclonic separation and the like.

After the precipitation step is complete, the solution of lithium hydroxide may be subjected to an isolation to produce solid lithium hydroxide.

The lithium hydroxide may be isolated as the monohydrate (LiOH·H₂O) or the anhydrate (LiOH) through evaporation of the liquid or by crystallisation. Suitable crystallisation techniques include antisolvent crystallisation wherein lithium hydroxide precipitates from solution upon addition of a suitable organic solvent such as acetone. The antisolvent may then be recovered after separation of the solid lithium hydroxide by, for example, distillation.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A method of direct lithium extraction from a lithium-containing feedstock, the method comprising:
(i) an extraction step, in which the lithium-containing feedstock solution is contacted with a lithium-ion-exchange material, whereby the lithium-ion-exchange material is loaded with lithium ions;
(ii) a release step, in which a release solution comprising a protic acid is contacted with the lithium-ion-exchange material, whereby lithium ions are released from the lithium-ion-exchange material into the release solution; and
(iii) a precipitation step, in which a precipitant is mixed with the lithium-enriched release solution; wherein the protic acid is an organic acid; and the precipitant is a non-lithium containing alkali.

2. The method according to claim 1 wherein the release solution comprises oxalic acid and/or citric acid.

3. The method according to claim 2 wherein the release solution is a 0.2 M citric acid solution.

4. The method according to claim 2 wherein the release solution is a 0.2 M oxalic acid solution.

5. The method of any one of the preceding claims wherein the precipitant is calcium hydroxide, magnesium hydroxide, or barium hydroxide.

6. The method of any one of the preceding claims wherein the lithium-ion-exchange material comprises lithium titanium oxide and/or hydrogen titanium oxide derived from lithium titanium oxide.

7. The method according to claim 6 wherein the lithium-ion-exchange material further comprises polyethersulfone.

8. The method of any one of the preceding claims further comprising a washing step after the extraction step and/or a washing step after the release step.

9. The method of any one of the preceding claims wherein the feedstock solution is adjusted to a pH >7 before the extraction step.

10. The method of any one of the preceding claims wherein the extraction step is performed at a temperature from 25 °C to 70 °C.

11. The method of any one of the preceding claims wherein the release step is performed at a temperature from 25 °C to 70 °C.
